(19) United States
(12) Patent Application Publication
(10) Pub. No.: US 2017/0160577 A1
(43) Pub. Date: Jun. 8, 2017

(54) Liquid Crystal Display Device And Liquid Crystal Panel Of The Same

(71) Applicant: Wuhan China Star Optoelectronics Technology Co., Ltd., Wuhan, Hubei (CN)

(72) Inventor: Yuejun TANG, Shenzhen, Guangdong (CN)

(73) Assignee: Wuhan China Star Optoelectronics Technology Co., Ltd., Wuhan, Hubei (CN)

(21) Appl. No.: 14/787,846

(22) PCT Filed: Jul. 23, 2015
(86) PCT No.: PCT/CN2015/084904

§ 371 Date: Oct. 29, 2015

(30) Foreign Application Priority Data
Jun. 16, 2015 (CN) 201510335009.2

(51) Int. Cl. G02F 1/1339; G02F 1/1333

(52) U.S. Cl. CPC G02F 1/13394; G02F 1/133305; G02F 1/133308; G02F 2001/13396; G02F 2201/56; G02F 2001/133354

(57) ABSTRACT

A liquid crystal panel includes a first and a second substrate disposed oppositely, liquid crystal molecules clamped there between, multiple first supporting bodies formed on the first substrate, and multiple second supporting bodies formed on the second substrate. The multiple first and the multiple second supporting bodies form a first and a second supporting pair. The first supporting pair is formed by one first and one second supporting body attached against with each other. The second supporting pair is formed by another first and another second supporting body attached against with each other. The first supporting body in the first supporting pair is disposed at a first side of the second supporting body. The first supporting body in the second supporting pair is disposed at a second side of the second supporting body. The present invention can prevent the first substrate from moving laterally with respect to the second substrate.

### BACKGROUND OF THE INVENTION

1. Field of the Invention

The present invention relates to a liquid crystal display technology field, and more particularly to a liquid crystal display device and a liquid crystal panel of the same.

2. Description of Related Art

A liquid crystal panel is a key component of a liquid crystal display device. Structure supporting bodies of the conventional liquid crystal panel are used for supporting a thin-film-transistor (TFT) substrate and a color filter (CF) substrate in order to form a cell thickness. The structure supporting bodies are disposed between the TFT substrate and the CF substrate in an equal height, an equal density and an equal size way. The above disposition way has some drawbacks.

In the recent years, a curved liquid crystal panel becomes more and more popular. However, because the curved liquid crystal panel has certain of curvature, a relative sliding will generated between the TFT substrate and the CF substrate after bending. The curved liquid crystal panel will generate a left sliding stress and a right sliding stress with respect to a center. The stresses will gradually decrease from the center to two sides, and an optical quality is decreased. Specifically, when applied in a flexible display, a decrease of a display quality because of a misalignment of an upper substrate and a lower substrate is more obvious. When a flat/curved/flexible liquid crystal display device receives an external push force or other forces, a misalignment of an upper substrate and a lower substrate is generated so as to affect the display quality.

Therefore, a liquid crystal display device and a liquid crystal panel of the same are required in order to solve the above technology problems.

### SUMMARY OF THE INVENTION

The main technology problem solved by the present invention is to provide a liquid crystal display device and a liquid crystal panel, which can prevent a first substrate from moving laterally with respect to a second substrate in order to increase the quality of the liquid crystal panel.

In order to solve the above technology problem, a technology solution adopted by the present invention is: a liquid crystal panel, comprising: a first substrate and a second substrate disposed oppositely; liquid crystal molecules clamped between the first substrate and the second substrate; multiple first supporting bodies formed on the first substrate; and multiple second supporting bodies formed on the second substrate; wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair; and wherein, two sides of the liquid crystal panel are respectively provided with the first supporting pair and the second supporting pair; a space between the first supporting body and the second supporting body which are attached against with each other ranges from 0 to 5 micrometers.

Wherein, the number of the first supporting bodies is less than the number of the second supporting bodies; each first supporting body and a corresponding second supporting body are attached against with each other in order to form the first supporting pair or the second supporting pair.

Wherein, at least a pair of adjacent first supporting bodies is disposed between a pair of adjacent second supporting bodies in order to form adjacent first supporting pair and second supporting pair.

Wherein, the number of the first supporting bodies and the number of the second supporting bodies are equal; the first supporting bodies and the second supporting bodies are corresponding one by one, and are attached against with each other in order form the first supporting pair and the second supporting pair.

In order to solve the above technology problem, another technology solution adopted by the present invention is: a liquid crystal panel, comprising: a first substrate and a second substrate disposed oppositely; liquid crystal molecules clamped between the first substrate and the second substrate; multiple first supporting bodies formed on the first substrate; and multiple second supporting bodies formed on the second substrate; wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair.

Wherein, the number of the first supporting bodies is less than the number of the second supporting bodies; each first supporting body and a corresponding second supporting body are attached against with each other in order to form the first supporting pair or the second supporting pair.

Wherein, between the first supporting pair and the second supporting pair, one or multiple second supporting bodies not mated with the first supporting bodies are provided.

Wherein, two sides of the liquid crystal panel are respectively provided with the first supporting pair and the second supporting pair.

Wherein, at least a pair of adjacent first supporting bodies is disposed between a pair of adjacent second supporting bodies in order to form adjacent first supporting pair and second supporting pair.

Wherein, the number of the first supporting bodies and the number of the second supporting bodies are equal; the first supporting bodies and the second supporting bodies are corresponding one by one, and are attached against with each other in order form the first supporting pair and the second supporting pair.

Wherein, the first supporting pair and the second supporting pair are arranged alternately.

Wherein, the liquid crystal panel is a curved panel, a flexible panel or a flat panel.

Wherein, a space between the first supporting body and the second supporting body which are attached against with each other ranges from 0 to 5 micrometers.

In order to solve the above technology problem, another technology solution adopted by the present invention is: a liquid crystal display device, wherein, the liquid crystal display device includes a backlight module and a liquid crystal panel, the backlight module is used for providing back lights to the liquid crystal panel, and the liquid crystal panel comprises: a first substrate and a second substrate disposed oppositely; liquid crystal molecules clamped between the first substrate and the second substrate; multiple first supporting bodies formed on the first substrate; and multiple second supporting bodies formed on the second substrate; wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair.

Wherein, the number of the first supporting bodies is less than the number of the second supporting bodies; each first supporting body and a corresponding second supporting body are attached against with each other in order to form the first supporting pair or the second supporting pair.

Wherein, between the first supporting pair and the second supporting pair, one or multiple second supporting bodies not mated with the first supporting bodies are provided.

Wherein, two sides of the liquid crystal panel are respectively provided with the first supporting pair and the second supporting pair.

Wherein, at least a pair of adjacent first supporting bodies is disposed between a pair of adjacent second supporting bodies in order to form adjacent first supporting pair and second supporting pair.

Wherein, the number of the first supporting bodies and the number of the second supporting bodies are equal; the first supporting bodies and the second supporting bodies are corresponding one by one, and are attached against with each other in order form the first supporting pair and the second supporting pair.

Wherein, the first supporting pair and the second supporting pair are arranged alternately.

The beneficial effect of the present invention is: comparing with the conventional art, in the present invention, the multiple first and the multiple second supporting bodies at least form a first and a second supporting pair. The first supporting pair is formed by one first and one second supporting body attached against with each other. The second supporting pair is formed by another first and another second supporting body attached against with each other. The first supporting body in the first supporting pair is disposed at a first side of the second supporting body. The first supporting body in the second supporting pair is disposed at a second side of the second supporting body. The present invention can prevent the first substrate from moving laterally with respect to the second substrate.

### BRIEF DESCRIPTION OF THE DRAWINGS

FIG. 1 is a schematic structure diagram of a liquid crystal panel according to a first embodiment of the present invention;

FIG. 2 is a schematic structure diagram of a liquid crystal panel according to another embodiment way in the first embodiment of the present invention;

FIG. 3 is a schematic structure diagram of a liquid crystal panel according to another embodiment way in the first embodiment of the present invention;

FIG. 4 is a schematic structure diagram of a liquid crystal panel according to a second embodiment of the present invention;

FIG. 5 is a schematic structure diagram of a liquid crystal panel according to another embodiment way in the second embodiment of the present invention;

FIG. 6 is a schematic diagram of a space between a first supporting body and a second supporting body which are attached against with each other; and

FIG. 7 is a schematic principle diagram of a liquid crystal display device according to the present invention.

### DETAILED DESCRIPTION OF THE PREFERRED EMBODIMENT

The following content combines with the drawings and the embodiment for describing the present invention in detail.

With reference to FIG. 1, and FIG. 1 is a schematic structure diagram of a liquid crystal panel according to a first embodiment of the present invention. In the present embodiment, the liquid crystal panel includes a first substrate 11 and a second substrate 12 which are disposed oppositely, and liquid crystal molecules 13 clamped between the first substrate 11 and the second substrate 12. The liquid crystal panel further includes multiple first supporting bodies 111 formed on the first substrate 11 and multiple second supporting bodies 121 formed on the second substrate 12. The multiple first supporting bodies 111 and the multiple second supporting bodies 121 at least form a first supporting pair A and a second supporting pair B. The first supporting pair A is formed by one first supporting body 111 and one second supporting body 121 attached against with each other. The second supporting pair B is formed by another first supporting body 111 and another second supporting body 121 attached against with each other. Each second supporting body 121 has a first side and a second side. The first side and the second side are opposite. The first supporting body 111 in the first supporting pair A is disposed at the first side of the second supporting body 121 in the first supporting pair A. The first supporting body 111 in the second supporting pair B is disposed at the second side of the second supporting body 121.

Preferably, as shown in FIG. 1, the first supporting body 111 in the first supporting pair A is disposed at a left side of the second supporting body 121. The first supporting body 111 in the second supporting pair B is disposed at a right side of the second supporting body 121. In another embodiment, another direction relationship can be existed according to different placement directions of a liquid crystal panel such as above and below. However, a direction of the first side and a direction of the second side must be opposite.

Preferably, the number of the first supporting bodies 111 is less than the number of the second supporting bodies 121. Besides, each first supporting body 111 and a corresponding second supporting body 121 are attached against with each other in order to form the first supporting pair A or the second supporting pair B.

Preferably, between the first supporting pair A and the second supporting pair B, one or multiple second supporting bodies 121 not mated with the first supporting bodies 111 are provided. In FIG. 1, two second supporting bodies 121 not mated with the first supporting bodies 111 is provided. It can be understood that between the first supporting pair A and the second supporting pair B, one or greater than two second supporting bodies 121 not mated with the first supporting bodies 111 can be provided.

Preferably, two sides of the liquid crystal panel are provided with the first supporting pair A and the second supporting pair B. That is, the left side and the right side of the liquid crystal panel as shown in FIG. 1 are respectively provided with one first supporting pair A and one second supporting pair B, and one first supporting pair A is disposed in a middle portion of the liquid crystal panel.

Preferably, a space between the first supporting body 111 and the second supporting body 121 which are attached against with each other ranges from 0 to 5 micrometers.

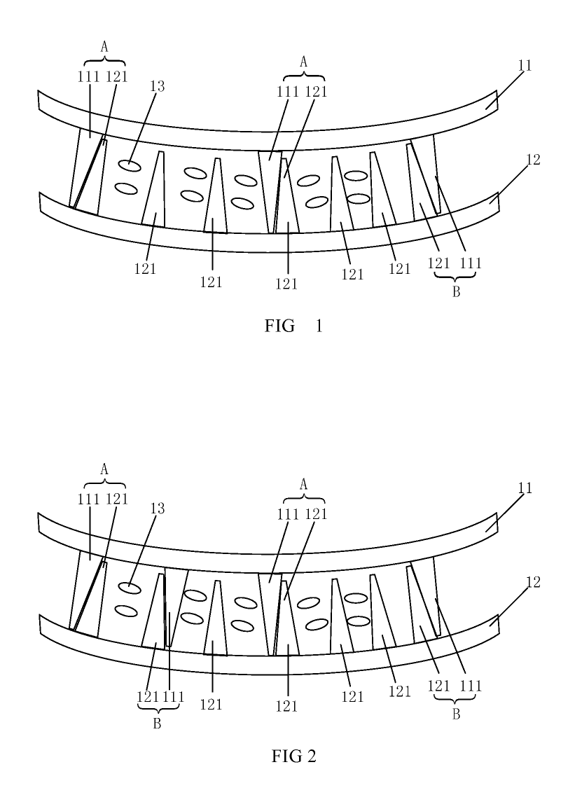

With reference to FIG. 2, and FIG. 2 is a schematic structure diagram of a liquid crystal panel according to another embodiment way in the first embodiment of the present invention. Preferably, at least a pair of adjacent first supporting bodies 111 is disposed between a pair of adjacent second supporting bodies 121 in order to form adjacent first supporting pair A and second supporting pair B.

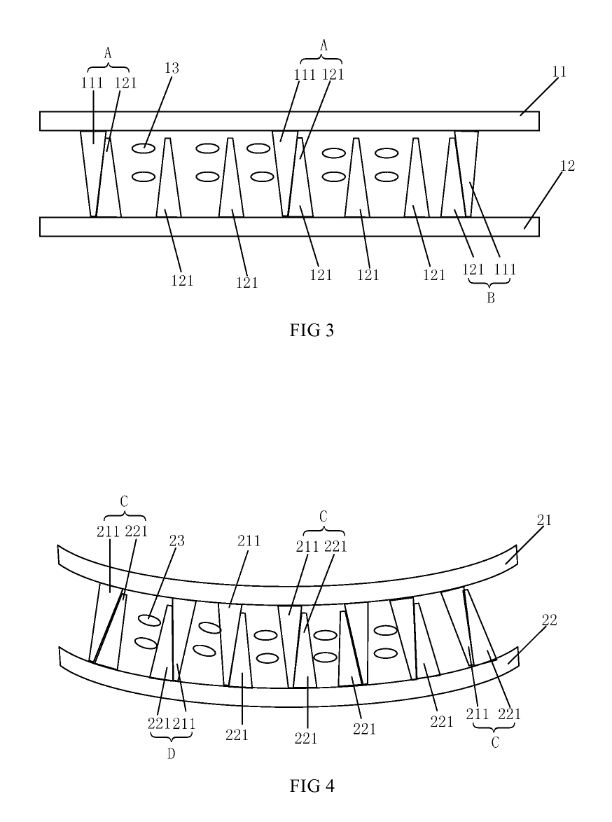

Preferably, the liquid crystal panel is a curved panel, a flexible panel or a flat panel. FIG. 1 only shows a curved panel, in another embodiment, a flat panel or a flexible panel may be provided. A flat panel means that the first substrate 11 and the second substrate 12 are both flat. A flexible panel means that the first substrate 11 and the second substrate 12 can be bent in a certain range, and a curvature can be changed. With reference to FIG. 3, and FIG. 3 is a schematic structure diagram of a liquid crystal panel according to another embodiment way in the first embodiment of the present invention. The liquid crystal panel is a flat panel.

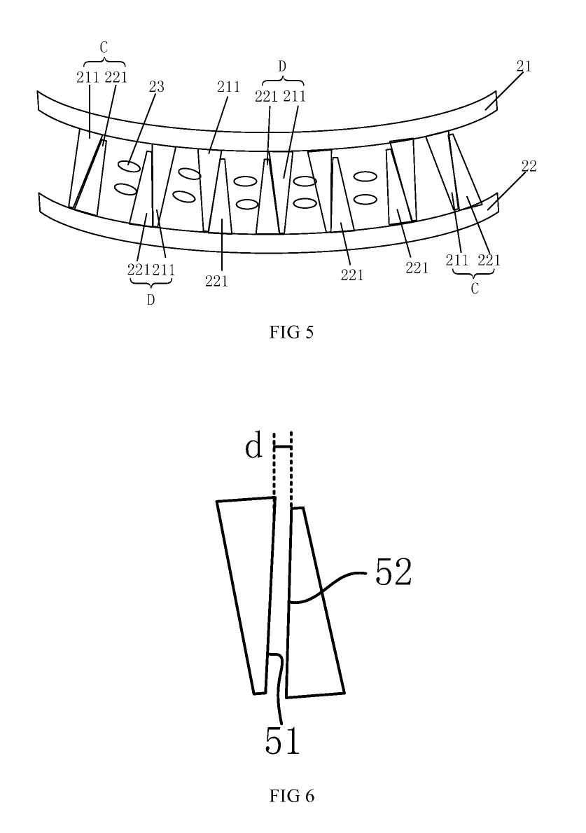

With reference to FIG. 4, FIG. 4 is a schematic structure diagram of a liquid crystal panel according to a second embodiment of the present invention. In the present embodiment, the liquid crystal panel includes a first substrate 21 and a second substrate 22 which are disposed oppositely, and liquid crystal molecules 23 clamped between the first substrate 21 and the second substrate 22. The liquid crystal panel further includes multiple first supporting bodies 211 formed on the first substrate 21 and multiple second supporting bodies 221 formed on the second substrate 22. The first supporting bodies 211 and the second supporting bodies 221 at least form a first supporting pair C and a second supporting pair D. The first supporting pair C is formed by a first supporting body 211 and a second supporting body 221 attached against with each other. The first supporting body 211 in the first supporting pair C is disposed at a first side of the second supporting body 221 in the first supporting pair C. The first supporting body 211 in the second supporting pair D is disposed at a second side opposite to the first side of the second supporting body 221 in the second supporting pair D.

Preferably, as shown in FIG. 4, the first supporting body 211 in the first supporting pair C is disposed at a left side of the second supporting body 221. The first supporting body 211 in the second supporting pair D is disposed at a right side of the second supporting body 221 in the second supporting pair D. In another embodiment, another direction relationship can be existed according to different placement directions of a liquid crystal panel such as above and below. However, a direction of the first side and a direction of the second side must be opposite.

Preferably, the number of the first supporting bodies 211 and the number of the second supporting bodies 221 are equal. The first supporting bodies 211 and the second supporting bodies 221 are corresponding one by one and are attached against with each other in order form the first supporting pair C and the second supporting pair D.

With reference to FIG. 5, FIG. 5 is a schematic structure diagram of a liquid crystal panel according to another embodiment way in the second embodiment of the present invention. In the present embodiment, the first supporting pairs C and the second supporting pairs D are arranged alternately. That is, in any two adjacent supporting pairs, when one of the two adjacent supporting pairs is a first supporting pair C, the other of the two adjacent supporting pairs is a second supporting pair D.

Preferably, the liquid crystal panel is a curved panel, a flexible panel or a flat panel. FIG. 4 only shows a curved panel, in another embodiment, a flat panel or a flexible panel may be provided. A flat panel means that the first substrate 21 and the second substrate 22 are both flat. A flexible panel means that the first substrate 21 and the second substrate 22 can be bent in a certain range, and a curvature can be changed. The situation of the flat panel can refer to the above content, no more repeating.

Preferably, a space between the first supporting body 211 and the second supporting body 221 which are attached against with each other ranges from 0 to 5 micrometers.

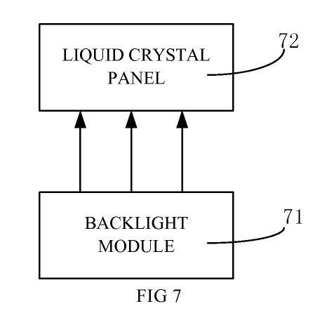

With reference to FIG. 6, FIG. 6 is a schematic diagram of a space between a first supporting body and a second supporting body which are attached against with each other. It should be noted that the space between the first supporting body and the second supporting body which are attached against with each other means a parallel distance d between two adjacent side 51 and side 52.

Preferably, in the above embodiments, the first supporting body is formed on the first substrate and supports the second substrate. The second supporting body is formed on the second substrate and supports the first substrate. Or, the second supporting body is formed on the second substrate, and does not support the first substrate. That is, a free end of the second supporting body does not abut against the first substrate, and the free end of the second supporting body is separated from the first substrate with a distance.

With reference to FIG. 7, and FIG. 7 is a schematic principle diagram of a liquid crystal display device according to the present invention. The liquid crystal display device includes a backlight module 71 and a liquid crystal panel 72. The liquid crystal panel 72 is the liquid crystal panel described in anyone of above embodiments. The backlight module is used for providing back lights for the liquid crystal panel 72.

In the present invention, the multiple first and the multiple second supporting bodies at least form a first and a second supporting pair. The first supporting pair is formed by one first and one second supporting body attached against with each other. The second supporting pair is formed by another first and another second supporting body attached against with each other. The first supporting body in the first supporting pair is disposed at a first side of the second supporting body. The first supporting body in the second supporting pair is disposed at a second side of the second supporting body. Through resisting between the first supporting body and the second supporting body, a large movement between an upper substrate and a lower substrate can be prevented. When a liquid crystal display device is under a lateral force, an affection of a display quality because of a misalignment of the upper and lower substrate can be prevented in order to improve the quality of the liquid crystal display panel.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal panel, comprising:
a first substrate and a second substrate disposed oppositely;
liquid crystal molecules clamped between the first substrate and the second substrate;
multiple first supporting bodies formed on the first substrate; and
multiple second supporting bodies formed on the second substrate;
wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair; and
wherein, two sides of the liquid crystal panel are respectively provided with the first supporting pair and the second supporting pair; a space between the first supporting body and the second supporting body which are attached against with each other ranges from 0 to 5 micrometers.

2. The liquid crystal panel according to claim 1, wherein, the number of the first supporting bodies is less than the number of the second supporting bodies; each first supporting body and a corresponding second supporting body are attached against with each other in order to form the first supporting pair or the second supporting pair.

3. The liquid crystal panel according to claim 1, wherein, at least a pair of adjacent first supporting bodies is disposed between a pair of adjacent second supporting bodies in order to form adjacent first supporting pair and second supporting pair.

4. The liquid crystal panel according to claim 1, wherein, the number of the first supporting bodies and the number of the second supporting bodies are equal; the first supporting bodies and the second supporting bodies are corresponding one by one, and are attached against with each other in order form the first supporting pair and the second supporting pair.

5. A liquid crystal panel, comprising:
a first substrate and a second substrate disposed oppositely;
liquid crystal molecules clamped between the first substrate and the second substrate;
multiple first supporting bodies formed on the first substrate; and
multiple second supporting bodies formed on the second substrate;
wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair.

6. The liquid crystal panel according to claim 5, wherein, the number of the first supporting bodies is less than the number of the second supporting bodies; each first supporting body and a corresponding second supporting body are attached against with each other in order to form the first supporting pair or the second supporting pair.

7. The liquid crystal panel according to claim 6, wherein, between the first supporting pair and the second supporting pair, one or multiple second supporting bodies not mated with the first supporting bodies is provided.

8. The liquid crystal panel according to claim 5, wherein, two sides of the liquid crystal panel are respectively provided with the first supporting pair and the second supporting pair.

9. The liquid crystal panel according to claim 5, wherein, at least a pair of adjacent first supporting bodies is disposed between a pair of adjacent second supporting bodies in order to form adjacent first supporting pair and second supporting pair.

10. The liquid crystal panel according to claim 5, wherein, the number of the first supporting bodies and the number of the second supporting bodies are equal; the first supporting bodies and the second supporting bodies are corresponding one by one, and are attached against with each other in order form the first supporting pair and the second supporting pair.

11. The liquid crystal panel according to claim 10, wherein, the first supporting pair and the second supporting pair are arranged alternately.

12. The liquid crystal panel according to claim 5, wherein, the liquid crystal panel is a curved panel, a flexible panel or a flat panel.

13. The liquid crystal panel according to claim 5, wherein, a space between the first supporting body and the second supporting body which are attached against with each other ranges from 0 to 5 micrometers.

14. A liquid crystal display device, wherein, the liquid crystal display device includes a backlight module and a liquid crystal panel, the backlight module is used for providing back lights to the liquid crystal panel, and the liquid crystal panel comprises:
a first substrate and a second substrate disposed oppositely;
liquid crystal molecules clamped between the first substrate and the second substrate;
multiple first supporting bodies formed on the first substrate; and
multiple second supporting bodies formed on the second substrate;
wherein, the multiple first supporting bodies and the multiple second supporting bodies at least form a first supporting pair and a second supporting pair; the first supporting pair is formed by one first supporting body and one second supporting body attached against with each other; the second supporting pair is formed by another first supporting body and another second supporting body attached against with each other; each second supporting body has a first side and a second side, and the first side and the second side are opposite; the first supporting body in the first supporting pair is disposed at the first side of the second supporting body in the first supporting pair; the first supporting body in the second supporting pair is disposed at the second side of the second supporting body in the second supporting pair.

15. The liquid crystal display device according to claim 14, wherein, the number of the first supporting bodies is less than the number of the second supporting bodies; each first supporting body and a corresponding second supporting body are attached against with each other in order to form the first supporting pair or the second supporting pair.

16. The liquid crystal display device according to claim 15, wherein, between the first supporting pair and the second supporting pair, one or multiple second supporting bodies not mated with the first supporting bodies are provided.

17. The liquid crystal display device according to claim 14, wherein, two sides of the liquid crystal panel are respectively provided with the first supporting pair and the second supporting pair.

18. The liquid crystal display device according to claim 14, wherein, at least a pair of adjacent first supporting bodies is disposed between a pair of adjacent second supporting bodies in order to form adjacent first supporting pair and second supporting pair.

19. The liquid crystal display device according to claim 14, wherein, the number of the first supporting bodies and the number of the second supporting bodies are equal; the first supporting bodies and the second supporting bodies are corresponding one by one, and are attached against with each other in order form the first supporting pair and the second supporting pair.

20. The liquid crystal display device according to claim 19, wherein, the first supporting pair and the second supporting pair are arranged alternately.
